(19) United States
(12) Patent Application Publication
(10) Pub. No.: US 2011/0266896 A1
(43) Pub. Date: Nov. 3, 2011

(54) ROTATING ELECTRIC MACHINE

(75) Inventor: Charles SMADJA, Toulouse (FR)

(73) Assignee: ALSTOM HYDRO FRANCE, Levallois Perret (FR)

(21) Appl. No.: 13/095,375

(22) Filed: Apr. 27, 2011

Related U.S. Application Data
(60) Provisional application No. 61/330,079, filed on Apr. 30, 2010.

(51) Int. Cl. H02K 1/20

(52) U.S. Cl. 310/59

(57) ABSTRACT

A rotating electric machine is provided and includes a rotor rotating around an axis and a stator concentrically surrounding the rotor. The stator is made up of a plurality of packages of laminations and includes a plurality of axial slots distributed along the inner circumference of the stator for receiving a stator winding. Cooling elements are provided within the stator to remove heat from the stator by a flow of cooling air flowing through said stator. The cooling efficiency and stator design are improved by providing radial and axial channels for the cooling air at the slots by combining packages of laminations with different shapes of the slot cut-outs.

### CROSS REFERENCE TO RELATED APPLICATION

This application claims the benefit of U.S. Provisional Application No. 61/330,079, filed Apr. 30, 2010, the entire contents of all of which is incorporated by reference as if fully set forth.

### FIELD OF INVENTION

The present invention relates to electric machines. It refers to a rotating electric machine according to the preamble of claim 1.

### BACKGROUND

Large diameter generators typically use radial vents for stator cooling. Generator stators are generally constituted by stacking thin laminations of magnetic steel. Laminations are stacked by packages of 20 mm-25 mm thickness. In-between two packages, a radial vent must be inserted to allow stator cooling. The heat dissipated in the stator winding must first cross the mass insulation by thermal conduction and then is spread away to the vent surface by thermal conduction in the laminations. Part of the conduction in the laminations is perpendicular to them with a very poor thermal conductivity. Stator cooling is then generally done by some air flow insufflated in the radial vents. Cooling efficiency is a function of the thermal conductivity of the stator laminations and of the velocity of the air flow insufflated in the radial vents.

Radial vents are generally constituted of bars (spacers) welded or glued on a metal sheet. These vents tend to increase the generator length. One issue is that the yoke has to be pressed along is length and the pressure is transmitted at the vent location through the spacers, resulting in stress concentration. In addition, when stacking of laminations is done with a robot, the robot must be stopped before each radial vent is piled up (radial vents are piled up manually).

Conventional stator designs require radial vents for stator cooling. These radial vents are mostly based on the principle disclosed in the U.S. Pat. No. 3,171,996, and shown in FIGS. 1 and 2. The rotating electric machine 20 of FIG. 2 comprises a central rotor 21 and a concentrically surrounding stator 22. The stator 22 is built up from packages of laminations 23. Between the packages radial vents 24 are provided for conducting cooling air through the stack. These radial vents 24 are inserted between two packages of laminations 23, every 20-25 mm (see FIG. 2). Some air flow is injected through these radial vents 24 to cool the stator bars of the stator winding.

Each vent includes actually two thick laminations (25 in FIG. 1) separated by spacers 26, 27 and 28. These laminations 25 are made thicker to better transmit the pressure. The thick laminations 25 have more losses due to variable field than the yoke laminations due to their thickness, typically 1 mm instead of 0.5 mm. In addition the rotor magnetic field creates some axial flux at the tooth edges (between the slots 29), increasing further the losses in the vent material.

### SUMMARY

The present disclosure is directed to a rotating electric machine including a rotor rotating around an axis and a stator concentrically surrounding the rotor. The stator is made up of a plurality of packages of laminations and includes a plurality of axial slots distributed along the inner circumference of the stator for receiving a stator winding. Cooling elements are provided within the stator to remove heat from the stator by a flow of cooling air flowing through said stator. The cooling efficiency and stator design are improved by providing radial and axial channels for the cooling air at the slots by combining packages of laminations with different shapes of the slot cut-outs.

### BRIEF DESCRIPTION OF THE DRAWINGS

The present invention is now to be explained more closely by means of different embodiments and with reference to the attached drawings.

FIG. 1 shows stator laminations with spacers for defining radial vents according to the prior art;

FIG. 2 shows a part of the rotating electric machine with radial vents in the stator according to the prior art;

FIG. 3 shows the laminations used for the machine according to FIG. 2;

FIG. 4 shows the laminations according to one embodiment of the present invention;

FIG. 5 shows the shape of the cut-out according to FIG. 3;

FIG. 6 shows the shape of the cut-out according to FIG. 4, which is used for building up an axial stator channel in accordance with an embodiment of the invention;

FIG. 7 shows the shape of an alternative cut-out, which is used for building up radial stator channels in accordance with an embodiment of the invention;

FIG. 8 shows in a perspective view a stator slot with axial and radial channels according to one embodiment of the invention;

FIG. 9 shows, in a perspective view, the stator slot of FIG. 8, which is closed with a wedge;

FIG. 10 shows a stator according to an embodiment of the invention, seen from outside; and

FIG. 11 shows the stator winding in the slot in an embodiment according to FIG. 10.

### DETAILED DESCRIPTION OF THE PREFERRED EMBODIMENTS

### Introduction to the Embodiments

It is an object of the present invention to provide a rotating electric machine with an improved and simplified stator cooling scheme, which avoids the disadvantages of known machines.

This object is obtained by a rotating electric machine according to claim 1. The rotating electric machine according to the invention comprises a rotor rotating around an axis and a stator concentrically surrounding the rotor, whereby the stator is built up from a plurality of packages of laminations and comprises a plurality of axial slots distributed along the inner circumference of the stator for receiving a stator winding, and whereby cooling means are provided within the stator for removing heat from the stator by a flow of cooling air flowing through said stator, and whereby radial and axial channels for the cooling air are provided at the slots by combining packages of laminations with different shapes of the slot cut-outs.

According to one embodiment of the invention there are first packages of laminations with slot cut-outs of a first shape, comprising a first slot area adapted to receive the stator winding and a second slot area arranged below and separated from the first slot area, whereby said second slot area defines an axial air collector channel, and there are second packages of laminations with slot cut-outs of a second shape, which each comprehend said first and second slot areas and have a width larger than the width of the stator winding to define radial cooling channels at one or both sides of the stator winding, and said first and second packages are arranged along the axis in an alternating fashion, such that a plurality of radial channels run through the stator to open into respective axial air collector channels.

According to another embodiment of the invention said laminations each have slot cut-outs of a first shape, comprising a first slot area adapted to receive the stator winding and a second slot area arranged below and separated from the first slot area, whereby said second slot area defines an axial air collector channel, and slot cut-outs of a second shape, which each comprehend said first and second slot areas and have a width larger than the width of the stator winding to define radial cooling channels at one or both sides of the stator winding, and similar laminations are put together in first and second packages, whereby said first and second packages are arranged along the axis in an alternating fashion, such that a plurality of radial channels run through the stator to open into respective axial air collector channels.

According to another embodiment of the invention each of said first and second packages has the same axial height and every two first packages alternate with a second package in axial direction.

According to another embodiment of the invention said laminations each have a thickness of less than 1 mm, preferably about 0.5 mm, and each of said first and second packages comprises about 20 to 30 laminations.

### DETAILED DESCRIPTION

The present invention provides a cooling scheme integrated in the stator laminations. Stator cooling is achieved through channels integrated in the laminations. Some air flow is insufflated in the stator, and the air flows in the integrated channels rather than in-between two radial vents. The cooling efficiency of this scheme is highly increased compared to conventional cooling systems using radial vents. This solution allows saving the cost of the radial vents. The generator stator is also shorter compared to conventional generator designs using radial vents. This leads to more compact generators, with shorter rotors. A shorter rotor means that less material is required to achieve the same electromagnetic forces. This leads to significant material cost reduction for the rotor, especially when permanent magnets are used. In addition, stacking operations are quite shorter when a robot is used (as stacking operations do not need to be stopped every time a radial vent must be inserted). The present invention allows also having a more compact stator, as the pressure force used to compact the laminations is not limited by the radial vents.

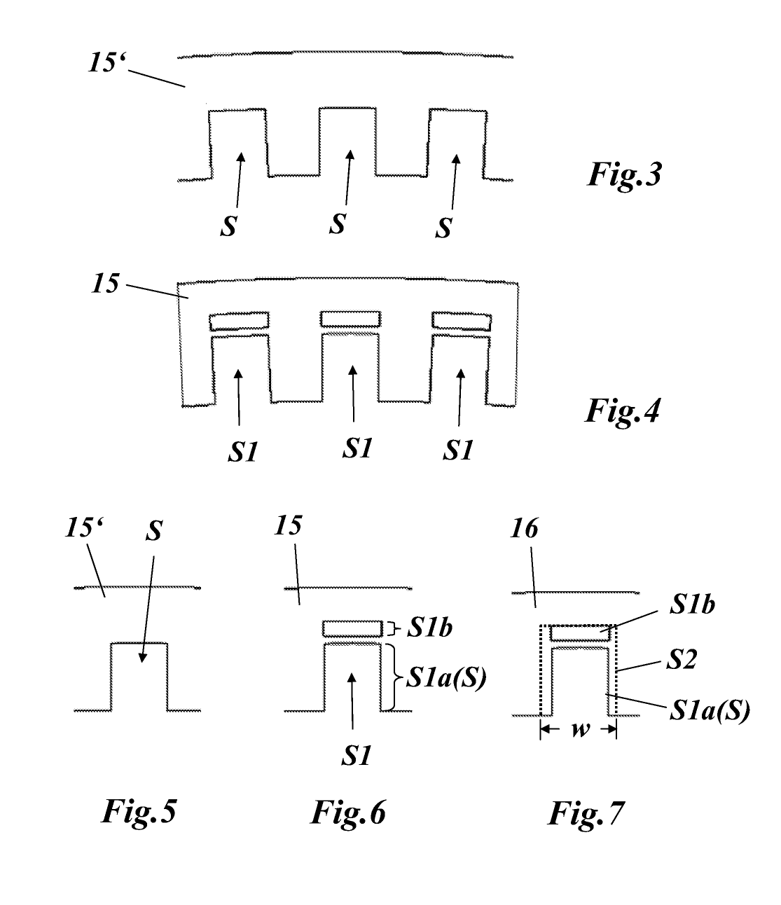

The present invention requires cutting laminations (by punching or by laser) with two different shapes for the slots (see FIG. 4 or 6 and FIG. 7). FIGS. 6 and 7 focus on a single generator slot. The various combinations of punching of different shapes in a lamination, and the combinations of stacking different laminations together will be detailed later.

As can be seen in comparison to the prior art slot with conventional slot shape S in laminations 15′ of FIG. 5, the shape S1 in laminations 15 of FIG. 6 is identical to the conventional slot, with a hole (slot area S1b), here shown rectangular, above the slot (slot area S1a) and separated by a bridge of non-removed steel.

The second slot shape S2 (dotted line) in laminations 16 of FIG. 7 provides a slot which is wider than the conventional one, and deeper because it includes the hole (slot area S1b) of slot shape S1 slots (FIG. 6).

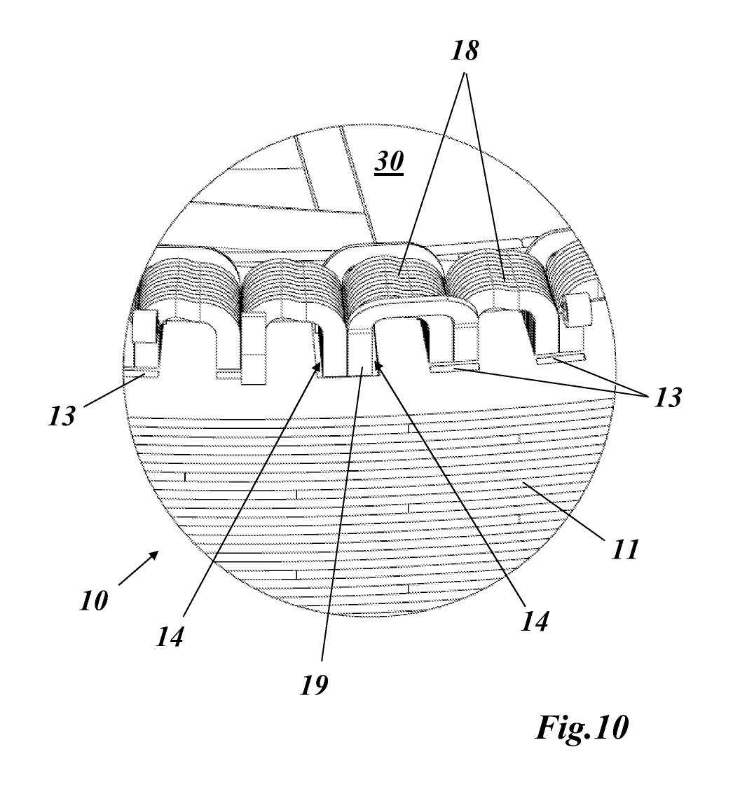

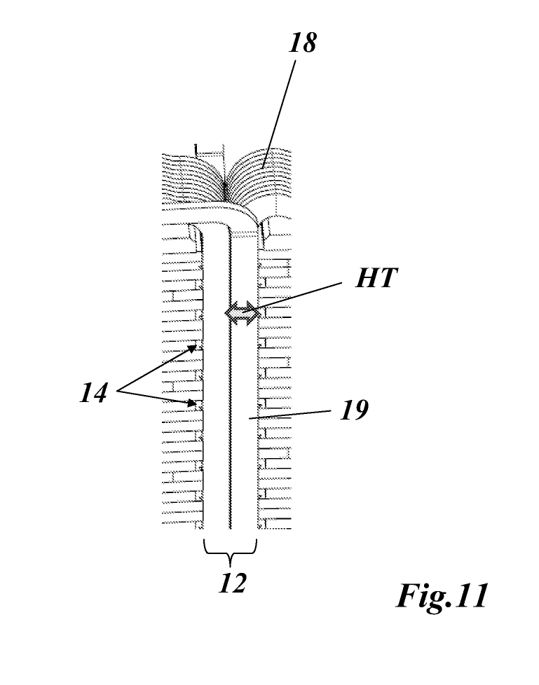

During stacking operations of the laminations 15 and 16, slot shape S1 and slot shape S2 are then assembled in a way allowing the creation of cooling channels all around the stator bars of the stator winding (18 in FIGS. 10 and 11). As can be seen in FIGS. 10 and 11, this assembly allows a continuous electric contact between the bars 19 and the laminations at the bottom of the slots of slot shape S1.

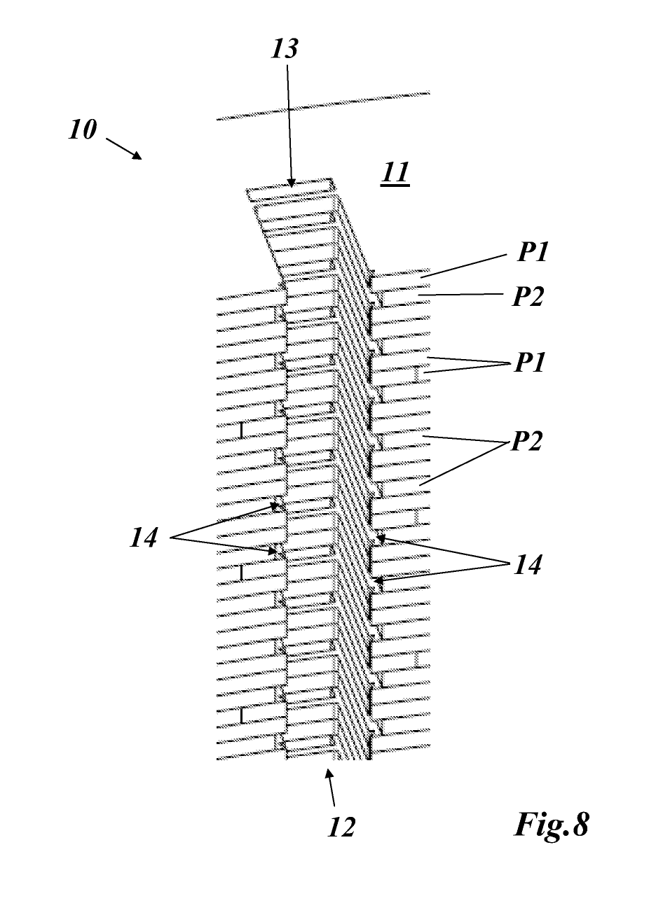

The invention addresses the creation of (radial) cooling channels (14 in FIG. 8 around the stator bars, together with the creation of an air collector channel (13 in FIG. 8) behind the slots.

An embodiment of the invention provides a stacking sequence using packages of laminations of 10-15 mm thickness, but the number of laminations used for each package can be customized according to the electromagnetic design requirements.

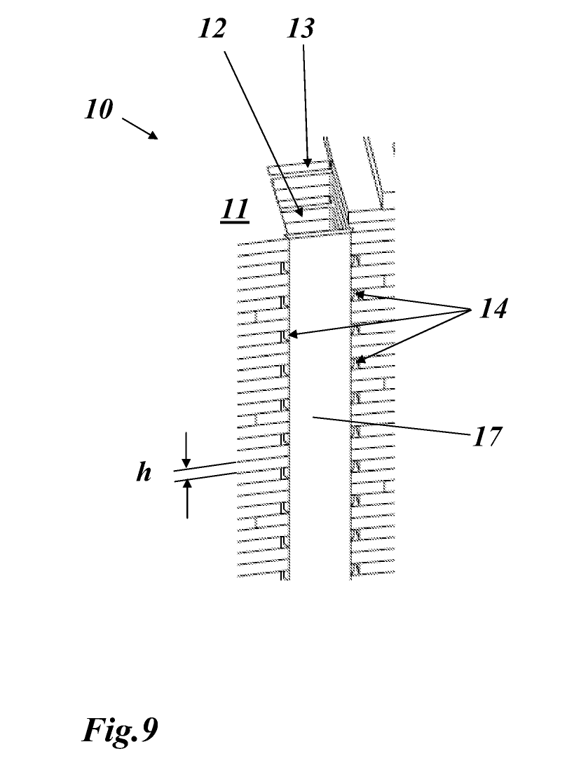

Laminations 15 punched or cut with slot shape S1 (collector channel 13 only) are stacked by packages P1 of a height h (FIG. 9) 10-15 mm (for example, 20 to 30 laminations of 0.5 mm thickness each).

Laminations 16 punched or cut with slot shape S2 (collector channel 13+lateral cooling channels 14) are stacked by packages P2 of a height h (FIG. 9) of 10-15 mm (for example, 20 to 30 laminations of 0.5 mm thickness each).

The height h of the packages P1 and P2 is identical in this embodiment, but may differ in special cases.

Packages of laminations 15 cut or punched with slot shape S1 are then piled up alternatively with packages of laminations 16 cut or punched with slot shape S2. FIG. 8 shows a combination of two packages P1 with slot shape S1 (collector only) for one package P2 with slot shape 2 (collector+cooling channel), but various other combinations can be envisaged according to the electromagnetic design requirements, as well as the cooling and mechanical requirements. Moreover, there may be combinations of S1 and S2 shapes within the same laminations.

The (radial) cooling channels 14 and the (axial) air collector channel 13 appear quite clearly when the slot 12 is represented together with the slot lock or wedge 17 (see FIG. 9).

With the invention, the stator bars 19 remain in contact with the back of the slot 12 (see FIG. 10). There is therefore no risk of partial discharge, as the same electric potential is kept.

Cooling Efficiency:

The invention provides a stator bar cooling efficiency higher than conventional stator design with radial vents:

Firstly, the number of cooling channels (14) counts by thousands whereas conventional radial vents counts by tens. The number and their dimensions can be optimized to achieve the relevant heat exchange requested by the application.

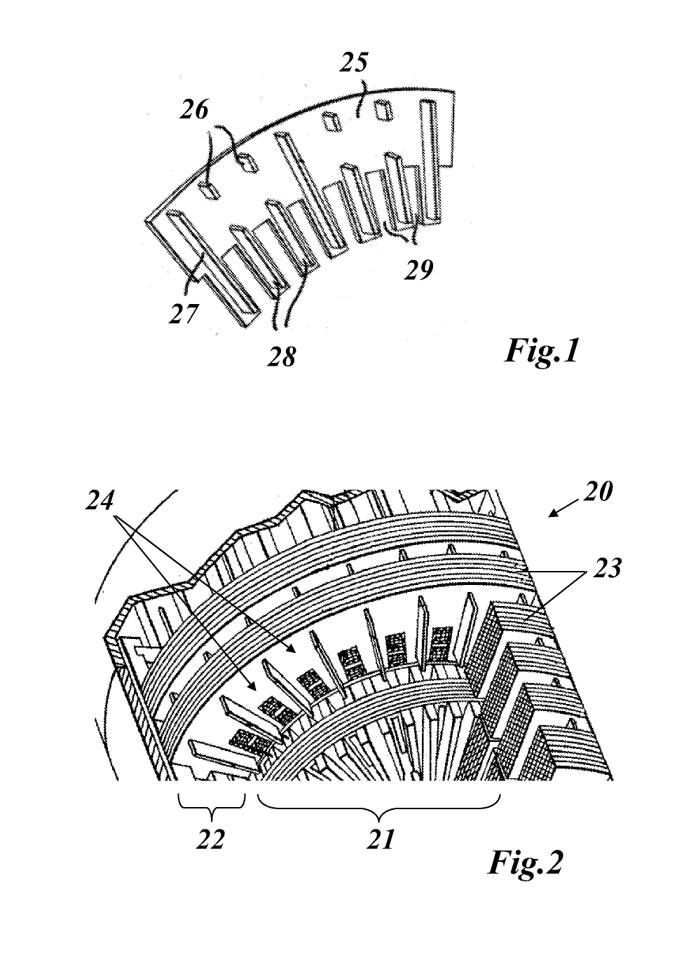

Secondly, compared to a conventional design using radial vents (see FIGS. 1 and 2), a larger surface area of the stator bar 19 is in direct contact with the cooling air, leading to a better cooling.

Thirdly, the heat conduction path across the laminations (heat transfer HT in FIG. 11) is extremely short compared to the conventional radial vents,

Fourthly, there are no additional iron losses due to the thick vent plates and due to the axial field at the bottom of teeth.

Fifthly, the iron losses and copper losses go through a parallel path whereas in conventional radial vents they add up on the thermal conduction path to the vents.

### SUMMARY OF THE ADVANTAGES OF THIS INVENTION

A better cooling efficiency (compared to a design with radial vents)
A modular cooling scheme that can fit exactly with the cooling requirements of the application
No need of radial vents, leading to:
   Less magnetic losses (radial event generate magnetic losses)
   A cost reduction (no radial event to be manufactured)
   A more compact stator
   A more compact rotor (the space occupied by the radial vents increases the rotor length accordingly)
   A more rigid stator (the laminations can be compacted with the desired pressure, independently of the limitations imposed by the radial vents)
   An assembly process with no interruption for the robot

### LIST OF REFERENCE NUMERALS

10, 20 rotating electric machine
11 stator
12 slot
13 air collector channel
14 cooling channel
15, 15′ laminations
16 laminations
17 wedge
18 stator winding
19 winding bar
21, 30 rotor
22 stator
23, 25 laminations
24 radial vent
26, 27, 28 spacer
29 slot
HT heat transfer
P1, P2 package (laminations)
S, S1, S2 slot shape (laminations)
S1a, S1b slot area
w width

What is claimed is:

1. Rotating electric machine (10), comprising a rotor (30), rotating around an axis, and a stator (11) concentrically surrounding the rotor (30), the stator (11) being comprised by a plurality of packages (P1, P2) of laminations (15, 16) and comprises a plurality of axial slots (12) distributed along an inner circumference of the stator (11) for receiving a stator winding (18), cooling elements (13, 14) are provided within the stator (11) to remove heat from the stator (11) by a flow of cooling air flowing through said stator (11), wherein radial and axial channels (13, 14) for the cooling air are provided at the slots (12) by combining packages (P1, P2) of laminations (15, 16) with different shapes (S1, S2) of the slot cut-outs.

2. Rotating electric machine according to claim 1, further comprising first packages (P1) of laminations (15) with slot cut-outs of a first shape (S1), comprising a first slot area (S1a) adapted to receive the stator winding (18) and a second slot area (S1b) arranged below and separated from the first slot area (S1a), wherein said second slot area (S1b) defines an axial air collector channel (13); and second packages (P2) of laminations (16) with slot cut-outs of a second shape (S2), which each include said first and second slot areas (S1a, S1b) and have a width (w) larger than the width of the stator winding (18) to define radial cooling channels (14) at one or both sides of the stator winding (18), said first and second packages (P1, P2) are arranged along the axis in an alternating fashion, such that a plurality of radial channels (14) run through the stator (11) to open into respective axial air collector channels (13).

3. Rotating electric machine according to claim 1, wherein said laminations (15, 16) each have slot cut-outs of a first shape (S1), comprising a first slot area (S1a) adapted to receive the stator winding (18) and a second slot area (S1b) arranged below and separated from the first slot area (S1a), said second slot area (S1b) defines an axial air collector channel (13), and slot cut-outs of a second shape (S2), which each include said first and second slot areas (S1a, S1b) and have a width (w) larger than the width of the stator winding (18) to define radial cooling channels (14) at one or both sides of the stator winding (18), similar laminations are put together in first and second packages (P1, P2), said first and second packages (P1, P2) are arranged along the axis in an alternating fashion, such that a plurality of radial channels (14) run through the stator (11) to open into respective axial air collector channels (13).

4. Rotating electric machine according to claim 2, wherein each of said first and second packages (P1, P2) has the same axial height (h), and every two first packages (P1) alternate with a second package (P2) in axial direction.

5. Rotating electric machine according to claim 3, wherein each of said first and second packages (P1, P2) has the same axial height (h), and every two first packages (P1) alternate with a second package (P2) in axial direction.

6. Rotating electric machine according to claim 1, wherein said laminations (15, 16) each have a thickness of less than 1 mm, preferably about 0.5 mm, and each of said first and second packages (P1, P2) comprises about 20 to 30 laminations.

7. Rotating electric machine according to claim 2, wherein said laminations (15, 16) each have a thickness of less than 1 mm, preferably about 0.5 mm, and each of said first and second packages (P1, P2) comprises about 20 to 30 laminations.

8. Rotating electric machine according to claim 3, wherein said laminations (15, 16) each have a thickness of less than 1 mm, preferably about 0.5 mm, and each of said first and second packages (P1, P2) comprises about 20 to 30 laminations.

9. Rotating electric machine according to claim 4, wherein said laminations (15, 16) each have a thickness of less than 1 mm, preferably about 0.5 mm, and each of said first and second packages (P1, P2) comprises about 20 to 30 laminations.

10. Rotating electric machine according to claim 5, wherein said laminations (15, 16) each have a thickness of less than 1 mm, preferably about 0.5 mm, and each of said first and second packages (P1, P2) comprises about 20 to 30 laminations.
